(19) United States
(12) Patent Application Publication
(10) Pub. No.: US 2010/0090888 A1
(43) Pub. Date: Apr. 15, 2010

(54) SBAS CORRECTION INFORMATION IN MS BASED AGPS SYSTEM

(76) Inventor: Ari Kangas, Lindingo (SE)

Correspondence Address: NIXON & VANDERHYE, PC, 901 NORTH GLEBE ROAD, 11TH FLOOR, ARLINGTON, VA, 22203, US

(21) Appl. No.: 12/523,588

(22) PCT Filed: Nov. 26, 2007
(86) PCT No.: PCT/SE07/50897

§ 371 Date: Nov. 12, 2009

(30) Foreign Application Priority Data
Jan. 30, 2007 (SE) PCT/SE2007/050044

(51) Int. Cl. G01S 19/40

(52) U.S. Cl. 342/357.02

(57) ABSTRACT

A method for providing a mobile station, being connected to a wireless communication system, with GPS assistance data, comprises obtaining (210) of correction data of a satellite based augmentation system. The method further comprises obtaining (220) of assistance data of an assisted global positioning system. Modified values of standard parameters of either assistance data of the assisted global positioning system or correction data of differential global positioning system, or both, are determined (230) from the correction data of the satellite based augmentation system in dependence on the assistance data of the assisted global positioning system. The modified values of the standard parameters are transmitted (240) from the core network to the mobile station. A node implementing the method and a system comprising such a node are also presented.

### TECHNICAL FIELD

The present invention relates in general to positioning within wireless communication systems and in particular to GPS-based positioning within wireless communication systems.

### BACKGROUND

Determination of the geographic position of an object, equipment or a person carrying the equipment has become more and more interesting in many fields of application. This is particularly true within the field of wireless communication. One approach to solve the positioning is to use signals emitted from satellites to determine a position. Well-known examples of such systems are the Global Positioning System (GPS) and the GLObal NAvigation Satellite System (GLONASS). The position is given with respect to a specified coordinate system as a triangulation based on a plurality of received satellite signals.

In traditional GPS, the Space Vehicles (SVs) transmit synchronous CDMA ranging signals characterized by a C/A (Coarse/Acquisition) code, repeating itself every 1 ms, that is unique to each SV. Superimposed on the C/A code is a sequence of −1 and +1 values containing frames of navigation data. The first task of the GPS receiver is to find the C/A code boundaries and the Doppler shift, detect the data bit and subframe boundaries. With this information, the receiver can determine the uncorrected raw pseudoranges to all SVs. The raw pseudoranges differ from the true range with perturbing factors like user and SV clock bias, relativistic effects and ionospheric and tropospheric delays, measurement noise and multipath disturbances. Once the receiver has synchronized, it can perform data demodulation and navigation data decoding. By using the navigation data it can correct the raw pseudoranges. It can also compute the SV precise locations at the time of transmission. When the receiver has found 3 or more satellites it can compute its own two-or three dimensional location.

A stand-alone GPS receiver has a number of disadvantages. If a position determination is to be performed for the first time, the positioning may take more than 30 s, since navigation data has to be decoded. Decoding of navigation data further requires higher signal levels than what is required for the actual positioning, which means that fewer SV signals are useful, which in turn affects the accuracy. If only a few SV are available and some of them provide to low signal levels, positioning may not even be possible to perform.

Assisted GPS (AGPS) is an attempt to improve the situation where the terminal to be positioned may acquire assistance data from other sources than directly from the satellites. In a typical case, in a terminal connected to a wireless communication system, assistance data can be sent to the mobile using a wireless data link. The assistance data thus provides a lot of the information that otherwise would have to be decoded from the satellite signals. This obviously improves the time to a first positioning, the positioning accuracy as well as the availability.

Two flavors of AGPS exist, mobile station (MS) based and MS assisted. In MS based AGPS, the MS receives navigation model, ionospheric model, approximate location and time from the network and computes its own location. In MS assisted AGPS, the MS receives only acquisition assistance and returns pseudorange measurements to the wireless communication network. The network then computes the position. Necessary communication protocols for AGPS are available in many wireless communications systems of today.

Where further increased accuracy is required, differential GPS (DGPS) can be been applied. Accuracy is improved by removing correlated errors between two or more receivers performing range measurements to the same satellites.

A stationary reference receiver with exactly known position can determine a difference between the known position and the position as determined by the GPS signals. This difference, expressed in terms of pseudorange corrections, is a measure of the errors at the measurement time and measurement position. Such differences can then be distributed to other terminals as an approximation of correlated errors. Standard DGPS provides only local corrections to the pseudoranges. There is no explicit modeling of the error as a function of location. As a rule of thumb one reference receiver every 500 km is enough.

The DGPS approach has the disadvantage that the pseudorange corrections in reality are localized, i.e. the accuracy of the correction degrades the farther you get from the DGPS correction source. Satellite based augmentation systems (SBAS) are used to complement satellite positioning systems like GPS with more accurate models and integrity monitoring. A number of stationary receivers are used to compute more accurate correction data, in particular concerning errors in ionospheric delays, short and long term clock errors and long-term ephemeris errors based on a comparison between the actual known position and the position as determined from the GPS signals. Such corrections are provided to a set of additional satellites, which may forward such information to GPS receivers. At the moment, three satellite systems are available for such SBAS corrections. European Geostationary Navigation Overlay System (EGNOS) operates in Europe, Wide Area Augmentation System (WAAS) operates in the US and MTSAT Satellite based Augmentation System (MSAS) operates in Japan. Accuracies down to about 1-2 m are claimed to be possible.

The differential corrections provided by SBAS systems differs e.g. from the DGPS standard. DGPS provides corrections that apply directly to the pseudoranges. SBAS corrections instead decompose the corrections into clock errors, ephemeris errors and ionospheric errors. Any mobile station that wants to make use of the SBAS corrections therefore has to be equipped for receiving and processing information in the SBAS format. For utilizing the SBAS information directly from the satellite systems, existing mobile stations have to be updated concerning both hardware and software. The implementation of SBAS will therefore be slow.

SBAS corrections may also be utilized within the framework of AGPS. For MS assisted AGPS all corrections are done in the network, so a complete SBAS support can easily be implemented, simply by updating a few reference receivers. For MS based AGPS, however, it is not obvious how to directly utilize the SBAS information. Currently no formats supporting SBAS information exist within the present cellular standards and it will probably not appear in the foreseeable future.

### SUMMARY

A general object of the present invention is to increase the possibilities to utilize SBAS correction information in MS based AGPS systems. A further object of the present invention is to make SBAS correction information available for mobile stations without need for hardware or software updates in the mobile stations.

The above objects are achieved by devices, systems and methods according to the enclosed patent claims. In general words, in a first aspect a method for providing a mobile station, being connected to a wireless communication system, with GPS assistance data, comprises obtaining of correction data of a satellite based augmentation system in a core network of the wireless communication system. The method further comprises obtaining of assistance data of an assisted global positioning system in the core network of the wireless communication system. Modified values of standard parameters of either assistance data of the assisted global positioning system or correction data of differential global positioning system, or both, are determined from the correction data of the satellite based augmentation system in dependence on the assistance data of the assisted global positioning system. The modified values of the standard parameters are transmitted from the core network to the mobile station.

In a second aspect, a node for use in a wireless communication system comprises a processor and an input connected to the processor, for correction data of a satellite based augmentation system. The processor has means for obtaining assistance data of an assisted global positioning system. The processor is further arranged for determining modified values of standard parameters of either assistance data of the assisted global positioning system or correction data of differential global positioning system, or both, from the correction data of the satellite based augmentation system in dependence on the assistance data of the assisted global positioning system. The node further comprises an output connected to the processor, for providing the modified values of the standard parameters.

In a third aspect, a wireless communication system comprises a node according to the second aspect.

One advantage with the present invention is that SBAS correction information can be utilized in already existing wireless communication systems without need for updates of the mobile stations or needs for any new signaling standards within the wireless communication systems. Mobiles not supporting differential SBAS corrections can therefore anyway benefit from the increased accuracy provided by SBAS.

### BRIEF DESCRIPTION OF THE DRAWINGS

The invention, together with further objects and advantages thereof, may best be understood by making reference to the following description taken together with the accompanying drawings, in which:

FIG. 1 illustrates an embodiment of a general stand-alone GPS system;

FIG. 2 illustrates an embodiment of a wireless communication system supporting MS assisted AGPS;

FIG. 3 illustrates an embodiment of a wireless communication system supporting MS based AGPS;

FIG. 4 illustrates a summary of GPS assistance data provided to a MS in a MS based AGPS approach;

FIG. 5 illustrates an embodiment of a wireless communication system supporting MS based DGPS;

FIG. 6 illustrates a summary of GPS assistance data provided to a MS in a MS based DGPS approach;

FIG. 7 illustrates an embodiment of a wireless communication system supporting SBAS enhanced MS assisted AGPS;

FIG. 8 illustrates a summary of SBAS correction data;

FIG. 9 schematically illustrates an object of the present invention;

FIG. 10 is a flow diagram illustrating steps of an embodiment of a method according to the present invention;

FIG. 11 is a flow diagram illustrating steps of an embodiment of a method using DGPS parameters according to the present invention;

FIG. 12 schematically illustrates an embodiment of a parameter conversion used for the method of FIG. 11;

FIG. 13 is a flow diagram illustrating steps of an embodiment of a method using AGPS parameters according to the present invention; and

FIG. 14 schematically illustrates an embodiment of a parameter conversion used for the method of FIG. 13;

FIG. 15 illustrates an embodiment of a wireless communication system according to the present invention;

FIG. 16 illustrates another embodiment of a wireless communication system according to the present invention; and

FIG. 17 illustrates yet another embodiment of a wireless communication system according to the present invention.

### DETAILED DESCRIPTION

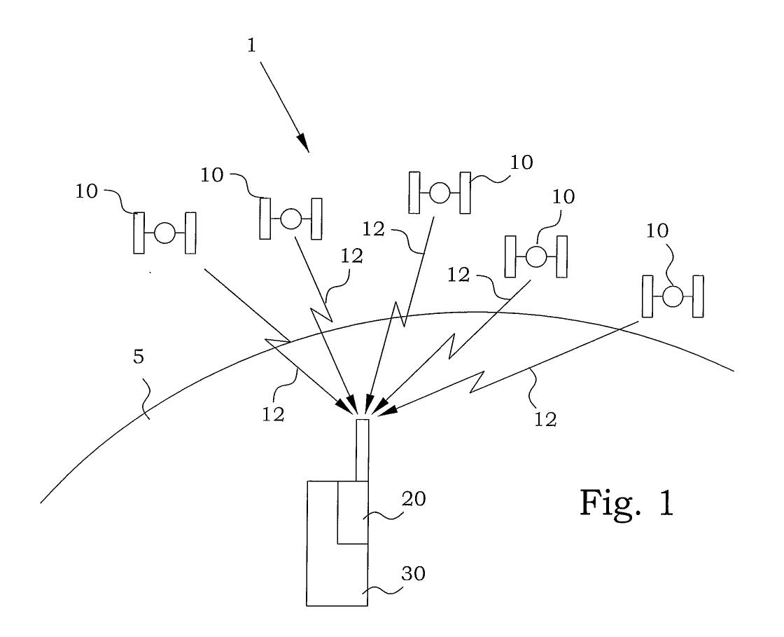

The description starts with a brief introduction to the different types of GPS-associated positioning approaches. FIG. 1 illustrates an embodiment of a general stand-alone GPS system 1.

The GPS system 1 consists of approximately 27 satellites, or space vehicles (SV) 10 orbiting the earth 5 at an altitude of 20000 km and with a period of 12 h. The SVs 10 travel with a speed of 3.8 km/s so the experienced Doppler shift at the earth 5 surface is significant. The SVs 10 transmit synchronous CDMA ranging signals 12 on an L1 frequency band (1575.42 MHz), characterized by a C/A code that is unique to each SV 10. The C/A code is a known sequence of −1 and +1 values that switch with a rate of 1.023 MHz. The C/A code repeats itself every 1 ms, i.e. it is 1023 chips long. Superimposed on the C/A code is a sequence of −1 and +1 values containing frames of navigation data, which switches at a rate of 20 ms. The navigation data represent models describing SV 10 orbits and clock models. The navigation data frame is divided into 5 subframes of 6 s each. This means that it may take 30 s to present a complete ephemeris, i.e. orbit, and clock correction model.

The ranging signals 12 are received by a GPS receiver 20. The GPS receiver may be a separate stand-alone GPS receiver, or as in the illustrated embodiment, part of a mobile station 30 of a wireless communication system.

A first task of the stand-alone GPS receiver 20 is to find the C/A code boundaries and the Doppler shift, detect the data bit and subframe boundaries. With this information, the GPS receiver 20 can determine uncorrected raw pseudoranges to all SVs 10. The raw pseudoranges differ from a true range with different perturbing factors. Such perturbing factors may be user and SV clock bias, relativistic effects and ionospheric and tropospheric delays, measurement noise and multipath dependencies.

Once the GPS receiver 20 has synchronized to the subframe boundaries it can perform data demodulation and navigation data decoding. By using the decoded navigation data it can then correct the raw pseudoranges for SV clock bias and relativistic effects and using models for ionospheric and tropospheric delays to compensate for these as well. It can also compute the SV 10 precise locations at the time of transmission. When the GPS receiver 20 has found 3 or more SVs 10 it can compute its own two-or three dimensional location by using e.g. a Taylor series approach.

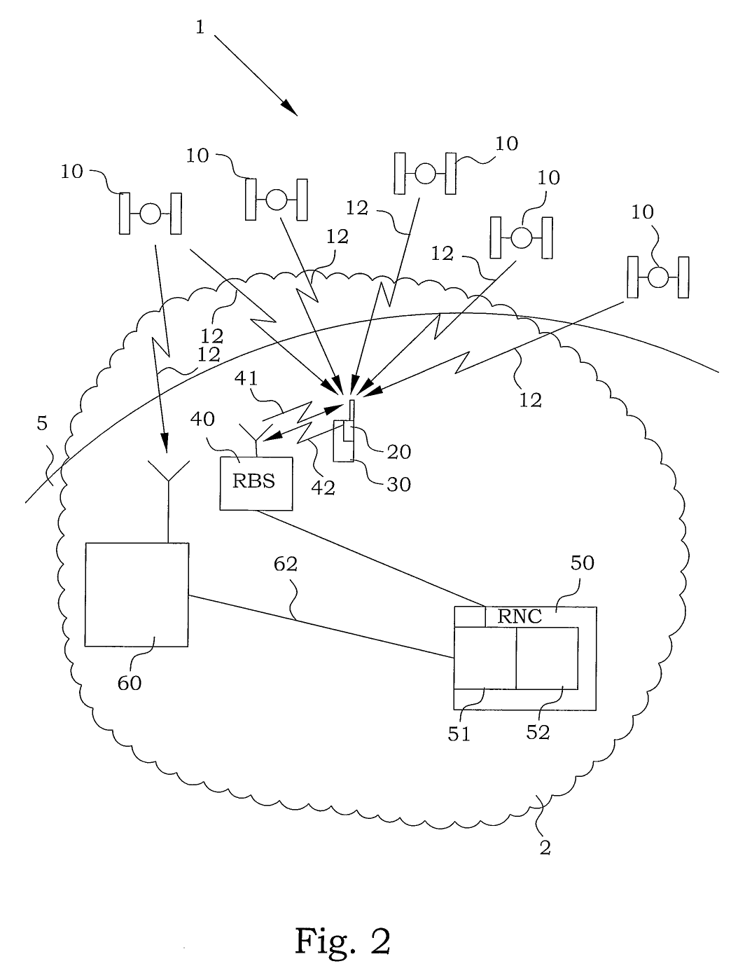

Assisted GPS attempts to improve or eliminate some of the steps of stand-alone GPS positioning. In order to do so, assistance data is sent to the mobile station using e.g. a wireless data link. FIG. 2 illustrates an embodiment of a wireless communication system 2, in this embodiment supporting MS assisted AGPS. A WCDMA cellular communication system is used in the present embodiment as a model wireless communication system. However, AGPS can be implemented in other communication systems as well. The ranging signals 12 from the SVs 10 are not only received by the GPS receiver 20, but also by a reference receiver 60 or a network of reference receivers. This reference receiver 60 is located at a site with favorable signal conditions. The reference receiver 60 may be integrated into the wireless communication system 2, as in the present embodiment, but may also be a separate system. The reference receiver may also be integrated e.g. with different nodes of the wireless communication system 2. The reference receiver 60 continuously tracks visible SVs 10 and decodes their messages. The GPS reference receiver 60 has therefore a complete set of information to be used for positioning purposes. The satellite data, or any representation thereof, is transferred as GPS model data 62 to a satellite positioning interface 51 in a radio network controller (RNC) 50 of the wireless communication system 2. The satellite positioning interface 51 extracts information necessary for supporting a rapid and accurate measurement of SV ranging signals 12 and provides such acquisition assistance data 41 via a radio base station (RBS) 40 to the MS 30. The MS 30 utilizes the acquisition assistance data 41 for performing the pseudorange measurements. The results of the pseudorange measurements are then returned 42 to the communication network, e.g. to a positioning node 52 of the RNC 50. The positioning node 52 can then compute a position for the MS 30 based on the pseudorange measurements from the MS 30 and the GPS model data 62 from the reference receiver 60.

The number of reference receivers needed in each cellular network depends on the size of the network. The basic design rule is that, collectively, the set of reference receivers should be able to measure all SVs that mobile stations located anywhere in the network can measure. This means that in practice only a few, e.g. 4, reference receivers are needed to cover a huge network covering e.g. US or Russia. Indeed, with an optimal placement of reference receivers, five receivers are enough to cover the whole globe. For small countries, one receiver may be enough for visibility reasons, although two may be necessary for redundancy.

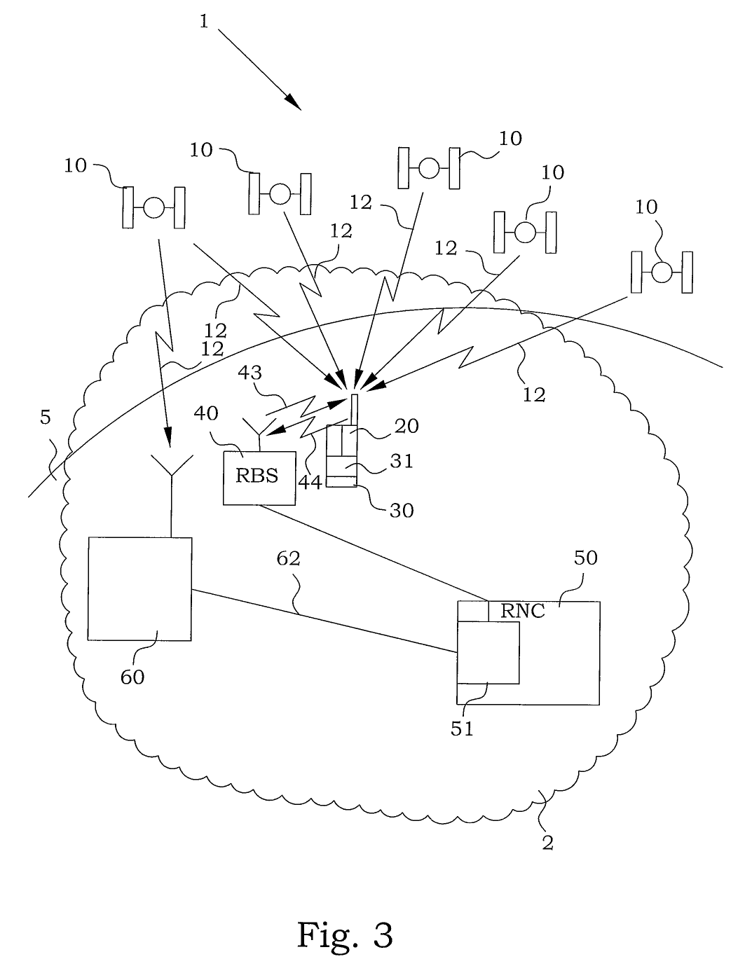

FIG. 3 illustrates an embodiment of a wireless communication system 2, in this embodiment supporting MS based AGPS. Also in this embodiment, a reference receiver 60 supports the wireless communication system 2 with GPS model data 62. However, in this embodiment, the satellite positioning interface 51 will now convert the GPS model data 62 into GPS assistance data 43 of a format compatible with signaling standards of the wireless communication system 2 for signaling to the MS 30. The satellite positioning interface 51 will also add network specific data, such as an approximate MS location and the relation between GPS and network time. An approximate MS location can e.g. be obtained by using cell ID positioning. The MS 30 receives the GPS assistance data 43 and performs pseudorange measurements. A positioning section 31 of the MS 30 utilizes the measured pseudoranges and the received GPS assistance data 43 to compute a position for the MS 30. Data 44 representing the position may then be communicated back to the communication network.

One of the benefits of AGPS is reduced time to a first positioning result. A stand-alone decoding of navigation data may take more than 30 s, while in AGPS, all navigation data is available almost immediately. Furthermore, an improved sensitivity is achieved, since C/A code boundaries can be detected at lower signal levels than what is required to decode the entire navigation data. The possibility to measure more satellites also indirectly affects the accuracy. Also the availability is improved if additional satellites can be measured, since at least three satellites are needed for a position.

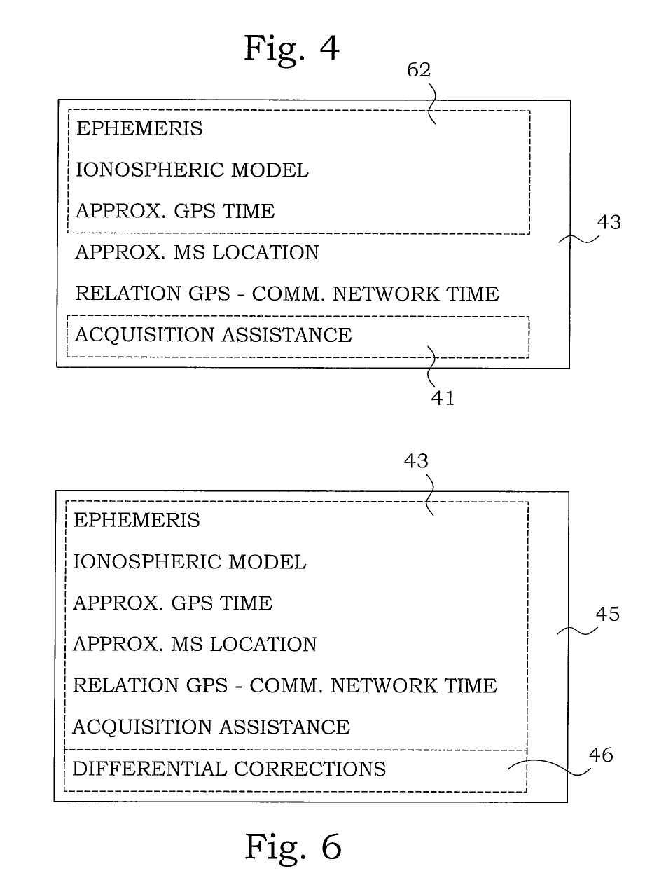

FIG. 4 illustrates a summary of the GPS assistance data 43 provided to the MS in a MS based AGPS approach. The GPS assistance data 43 of an assisted global positioning system is provided in the core network of the wireless communication system. One of the most important assistance data types are ephemeris and clock corrections for visible SVs, called navigation model, and an ionospheric model for visible SVs. An approximate GPS time and acquisition assistance data 41 are all comprised in the GPS model data 62 and also in the GPS assistance data 43. The acquisition assistance data 41 typically comprises expected code phases and Doppler shifts and associated uncertainties for SVs visible at the MS location. The network adds data such as the approximate MS location and the relation between GPS and wireless communication network time.

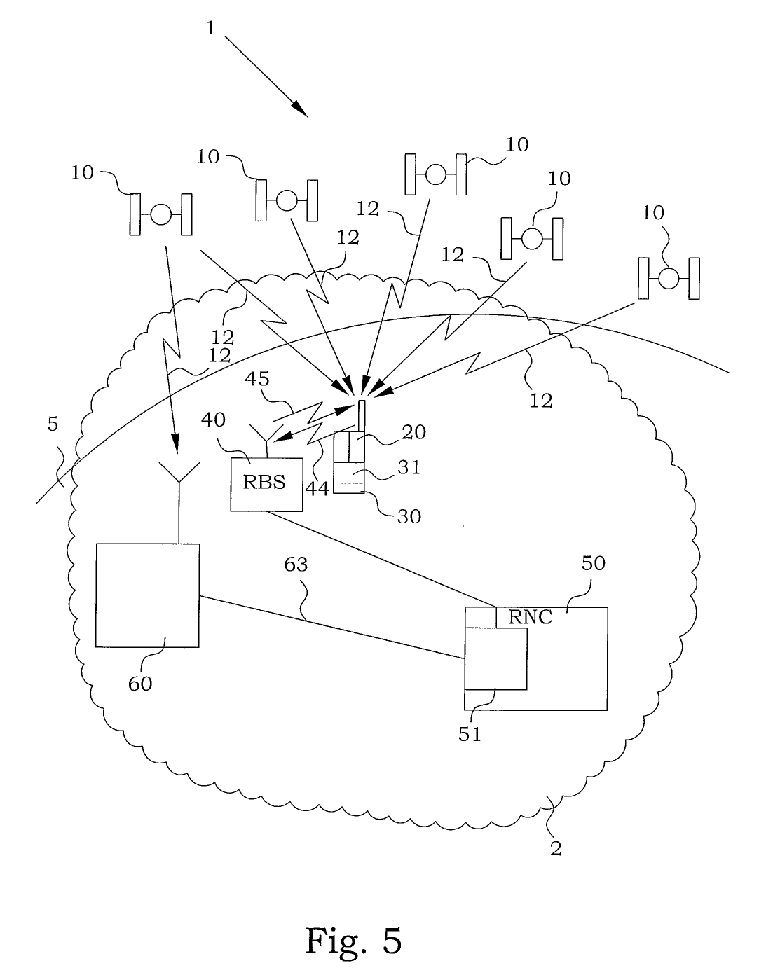

As mentioned in the background, DGPS provides possibilities for more accurate positioning. FIG. 5 illustrates an embodiment of a DGPS system. The GPS reference receiver 60 is in this embodiment also able to provide differential corrections. The GPS model data 63 provided to the wireless communication network 2 comprises therefore in the present embodiment both “ordinary” information from the GPS system as well as differential corrections computed based on differences between real and estimated position of the reference receiver 60. In this embodiment, the satellite positioning interface 51 converts the GPS model data 63 into DGPS assistance data 45 of a format compatible with signaling standards of the wireless communication system 2 for signaling to the MS 30. The MS 30 receives the GPS assistance data 45 and performs pseudorange measurements. A positioning section 31 of the MS 30 utilizes the measured pseudoranges and the received GPS assistance data 45 to compute a position for the MS 30. In particular, the differential corrections are used for correcting the measures pseudoranges. Data 44 representing the position may then be communicated back to the communication network.

FIG. 6 illustrates a summary of the GPS assistance data 45 correction data of DGPS provided to the MS in a MS based DGPS approach. The GPS assistance data 45 of a DGPS system is provided in the core network of the wireless communication system. The GPS assistance data 45 comprises the GPS assistance data 43 for a MS based AGPS system as well as parameters of correction data 46 concerning pseudorange errors. Unfortunately, despite that most wireless communication networks of today do have standardized formats including the correction data 46 most mobile stations do not support such options.

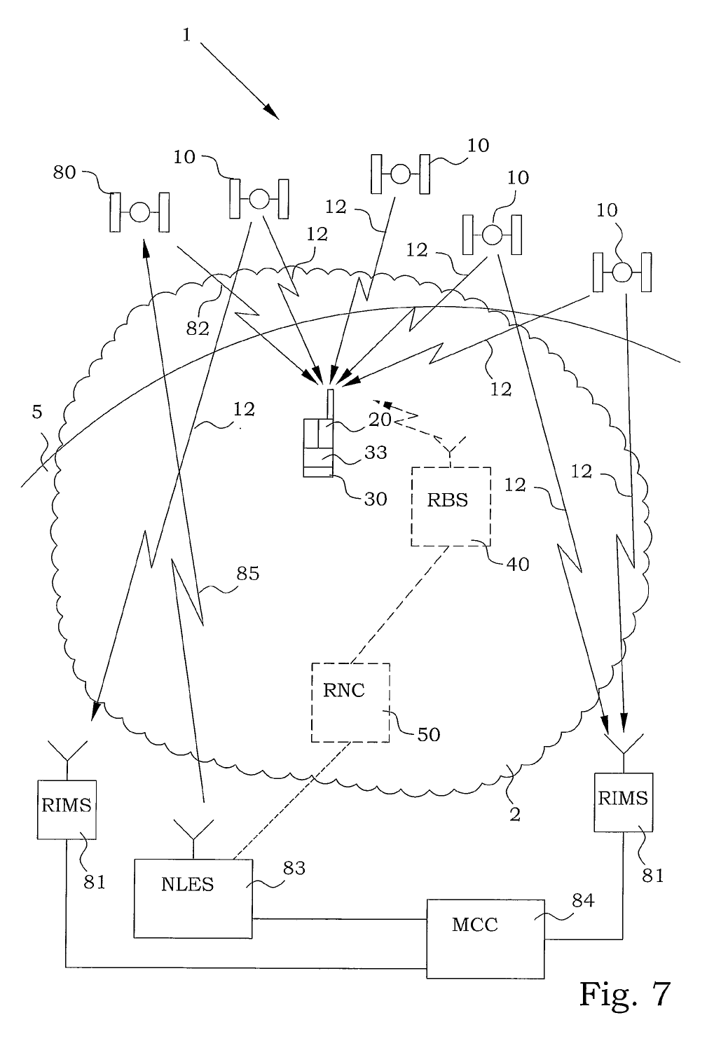

FIG. 7 illustrates a satellite based augmentation system (SBAS) of GPS implemented in a wireless communication system 2. It is well known that GPS can provide users with highly accurate location estimates almost everywhere on earth, provided that the signals are not blocked by the environment. However for safety critical applications like civil aviation, some elements are missing in the standard systems today. There is e.g. no quick way to alert the user that a satellite signal is degrading such that accuracy is lost. In addition current differential GPS systems suffer from being only localized, i.e. the accuracy degrades the farther you get from the DGPS correction source.

Satellite based augmentation systems (SBAS) are therefore used to complement satellite positioning systems like GPS with for instance integrity monitoring, i.e. alerts of the user when a satellite signal is no longer reliable. Furthermore, SBAS complements provides for more accurate models for ionospheric delays than those obtained by standard GPS. Furthermore, short- and long-term clock error corrections and long-term ephemeris corrections are available. Since a typical distribution of the SBAS information is performed via satellites, there are also additional satellites to perform pseudorange measurements on.

SBAS is implemented by using geostationary satellites 80 that transmit a GPS-like signal 82. EGNOS is one example of a satellite system that can be used for SBAS corrections. The EGNOS will be used as a model system in the present description. However, also other satellite systems can be used for the same purpose, e.g. WAAS or MSAS. It is claimed that by using EGNOS correction data, accuracy can be improved from 15 m to 1-2 m.

The EGNOS network consists of ranging and integrity monitoring stations (RIMS) 81, master control centers (MCC) 84 and Navigation Earth-Land Stations (NLES) up-link stations 83. The RIMS 81 measure pseudoranges and transmit the measurements to MCC 84. MCC 84 estimates correction data and sends these to NLES 83 which send the updated correction data 85 to the EGNOS satellites 80. The mobile station 30 can then read the corrections from the EGNOS satellite signals 82 and use these on the navigation solution. This requires a SBAS correction application 33 in the MS 30.

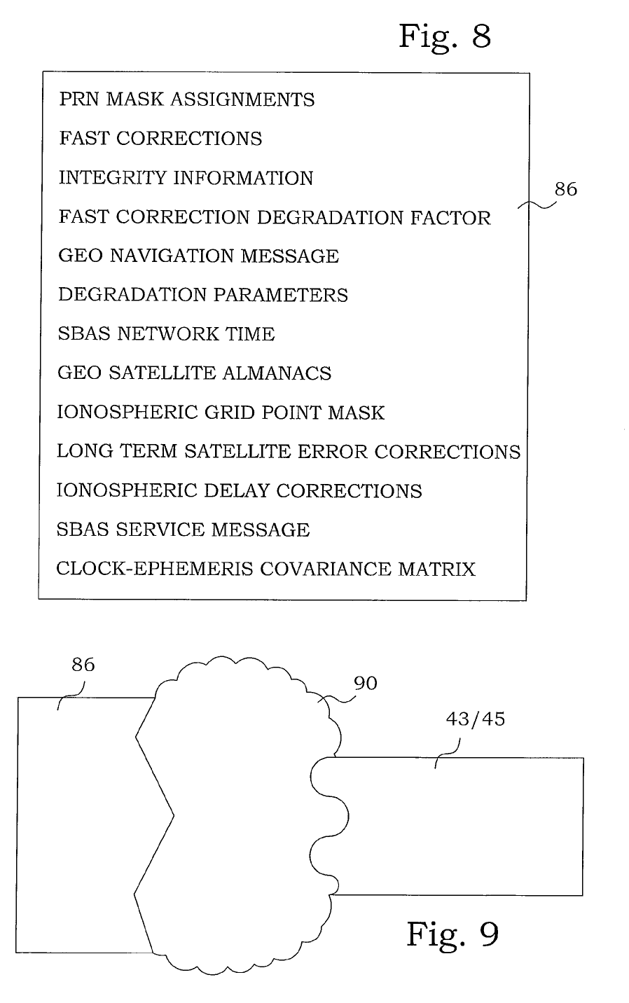

EGNOS can be used for AGPS by utilizing a reference receiver 60 capable of receiving EGNOS signals 82. EGNOS, however, provides differential corrections in a format which differs from the DGPS standard. SBAS based systems decompose the correction data into clock errors, ephemeris errors and ionospheric errors. In addition a new tropospheric model is used. A list of EGNOS messages 86 is shown in FIG. 8.

The long term satellite error corrections are important corrections. These corrections comprise long term corrections to satellite positions and clocks. The clock correction is:

dΔtₛᵥ(t)=dα_{ƒ0}+dα_{ƒ1}(t−t₀ (1)

where the correction is added to Δtₛᵥ (the satellite dock error).

The ephemeris correction is:

$$[ \begin{matrix}dx \\ dy \\ dz\end{matrix} ] = [ \begin{matrix}dx \\ dy \\ dz\end{matrix} ] + [ \begin{matrix}\text{?} \\ \text{?} \\ \text{?}\end{matrix} ] ( t - {t}_{0} ) \\ \text{?} \text{indicates text missing or illegible when filed} \qquad ( 2 )$$

These corrections are added to the SV coordinates in ECEF (Earth Centered Earth Fixed) coordinate system.

Ionospheric corrections are also of high importance. These ionospheric corrections contain a model over the ionospheric delay at ionospheric grid points (IGP) distributed over the earth.

To apply the ionospheric corrections, the user needs to do the following:

1. Determine, for each satellite, a pierce point. This point is where a line from the user to the satellite intersects the WGS84 ellipsoid at 350 km altitude.

2. Determine the IGP points to use for interpolation. This can be a rectangle of width 5 or 10 degrees or a triangle, or in the polar regions, 4 surrounding grid points.

3. 2-dimensional interpolation of the vertical delay and uncertainty at the pierce point.

4. Calculate slant delay taking into account the incident angle into the ionosphere.

SBAS corrections are easily available in the reference receiver 60 and MS assisted GPS positioning can easily benefit from such corrections. However, by comparing the sets of data presented in FIGS. 4, 6 and 8, corresponding to assistance data for MS based AGPS, DGPS and the SBAS corrections, respectively, one immediately realizes that SBAS corrections can not directly be provided to the MS's using standard procedures.

FIG. 9 schematically illustrates a conceptual model of the present invention. A set of valuable SBAS corrections 86 are available in the wireless communication network. For communication with the MS's, AGPS or DGPS assistance data 43 or 45, respectively, are provided for in different standards. A concept of the present invention 90 is to convert information comprised in the SBAS corrections 86 into standard parameters of assistance data 43 or 45, i.e. acting as a link between the parameter space of SBAS and the parameter space of AGPS/DGPS.

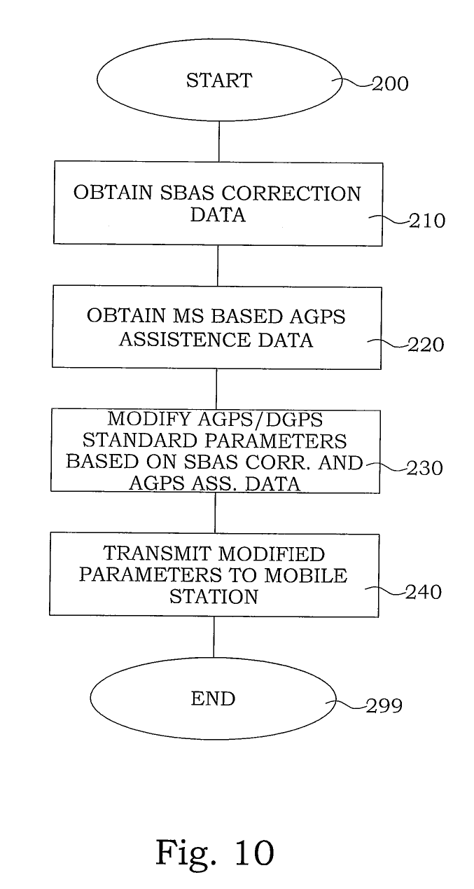

FIG. 10 illustrates a flow diagram of steps of an embodiment of a method according to the present invention. The procedure for providing a mobile station, being connected to a wireless communication system, with GPS assistance data begins in step 200. In step 210, correction data of a satellite based augmentation system is obtained in a node of the wireless communication system. Such correction data can be obtained by receiving signals from satellites of a satellite system supporting the SBAS corrections. However, correction data may also be received, by the wireless communication system, e.g. directly from a SBAS node, e.g. the NLES 83 (FIG. 7) as indicated by the dotted line in FIG. 7. In step 220 assistance data of an assisted global positioning system is obtained in the node of the wireless communication system. Modified values of standard parameters of at least one of assistance data of the assisted global positioning system and correction data of a differential global positioning system are determined from the correction data of the satellite based augmentation system in dependence on the assistance data of the assisted global positioning system, in step 230. Finally, in step 240, the modified values of the standard parameters are transmitted from the node to the mobile station. The procedure ends in step 299.

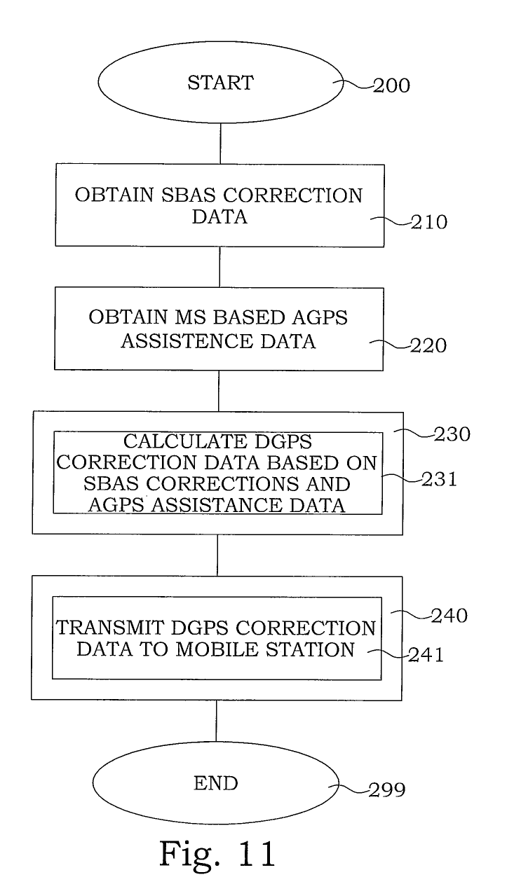

FIG. 11 illustrates a flow diagram of an embodiment of a method, where DGPS range correction data is allowed to be transferred to the MS. The MS thus supports DGPS. Step 230 here comprises a step 231, in which a value of a parameter of range correction data of the differential global positioning system is calculated from the correction data of a satellite based augmentation system and the assistance data of the assisted global positioning system.

This embodiment thus utilizes an alternative to convert the SBAS correction model into DGPS corrections. This is in a preferred embodiment done as follows (for each satellite). An approximate location of the MS and the satellite coordinates are calculated in ECEF. After ECEF rotation, the uncorrected range rᵤ is calculated. Long-term corrections to the satellite coordinates are then applied. After ECEF rotation, the corrected range r_{c} is calculated. The expected ionospheric delay Tᵢₒₙₒ is thereafter calculated as described further above. The tropospheric delay Tₜᵣₒₚ is then calculated according to standard procedures. The long term clock corrections T_{c} are applied according to the description further above. Finally the pseudorange correction is computed as:

ρ_{c}=rᵤ−r_{c}−c*(T_{c}+Tᵢₒₙₒ+Tₜᵣₒₚ) (3)

The step 240 consequently comprises the step 241 of transmitting DGPS assistance data to the MS. The MS receives the modified DGPS assistance data and processes it according to the standard routines. The MS is therefore totally unaware of that the SBAS corrections are utilized. However, the present embodiment requires that the MS support differential corrections, which is not the case at many occasions. The present solution therefore cannot be applied in all cases.

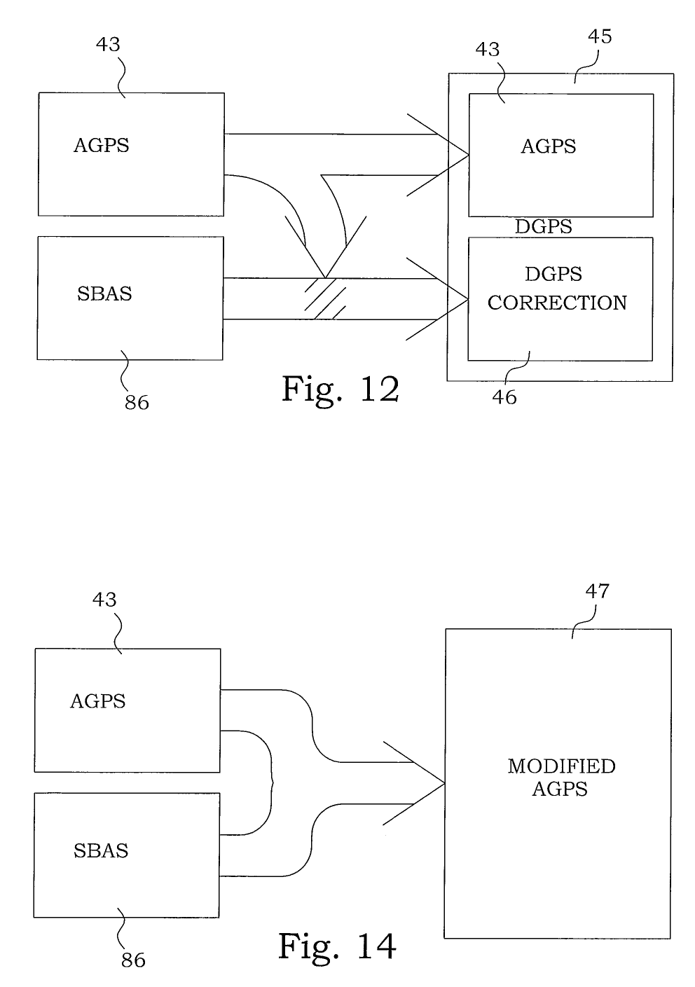

FIG. 12 schematically illustrates an embodiment of a parameter conversion used for the method above. AGPS assistance data 43 for MS based AGPS and SBAS correction data 86 are obtained. The AGPS assistance data 43 is forwarded as the AGPS assistance data 43 part of the DGPS assistance data 45, basically without modifications. The SBAS correction data 86 is evaluated based on or dependent on the AGPS assistance data 43. From the evaluation, modified DGPS corrections 46 are provided to be included in the DGPS assistance data 45. The evaluation is thus dependent on the AGPS assistance data, which means that two identical sets of SBAS corrections will lead to different evaluations for systems having differing AGPS assistance data. This is quite obvious, since SBAS corrections are connected to model corrections, whereas DGPS corrections deal with actual pseudorange corrections. The relation therebetween is obviously dependent on the position of the MS, and thereby on the AGPS assistance data.

For wireless communication systems or MS's not supporting DGPS, a somewhat more complex approach has to be taken. The idea of an embodiment according to this approach is to modify parameter values of the basic assistance data, i.e. ephemeris, clock corrections and ionospheric models, so that the resulting output, i.e. clock correction, SV position and ionospheric delay, are almost identical to what would have been obtained by combining the SBAS corrections directly on the basic assistance data.

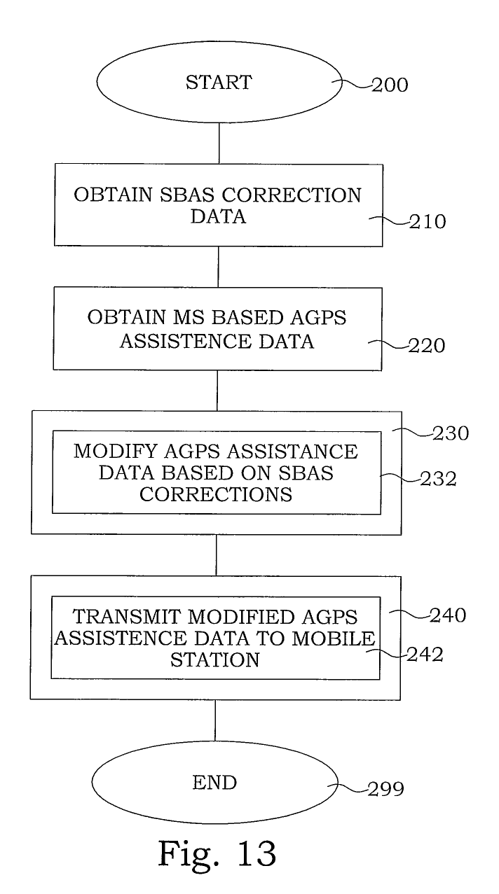

FIG. 13 illustrates a flow diagram of an embodiment of a method, where AGPS assistance data is allowed to be transferred to the MS. Step 230 here comprises a step 232, in which obtained values of standard parameters of the assistance data of the assisted global positioning system are modified based on the correction data of the satellite based augmentation system.

The step 240 consequently comprises the step 242 of transmitting AGPS assistance data to the MS. The MS receives the modified AGPS assistance data and processes it according to the standard routines. The MS is therefore totally unaware of that the SBAS corrections are utilized. However, the present embodiment requires that the MS supports MS based AGPS.

FIG. 14 schematically illustrates an embodiment of a parameter conversion used for the method above. AGPS assistance data 43 for MS based AGPS and SBAS correction data 86 are obtained. The parameters of the AGPS assistance data are modified into a modified set of parameters of AGPS assistance data 47. This modification is based on the SBAS correction data 86.

In a preferred embodiment, the modification of the AGPS assistance data is performed by making a Taylor series expansion around nominal values of a selection of assistance data parameters, and then solving a resulting linear system of equations for the modified parameters.

The step of modifying preferably comprises modifying of a value of at least one parameter of a clock correction of the assistance data of the assisted global positioning system. Assume that the original clock correction parameters in the basic assistance data are a_{f0}, a_{f1}, a_{f2} and a time t_{oc}. The MS that receives the assistance data compensates its clock by subtracting:

Δtₛᵥ(t)=a_{f0}+a_{f1}(t−t_{oc})+a_{f2}(t−t_{oc})²+Δtᵣ (4)

Δtᵣ is a relativistic correction which is not important for the present discussion and is ignored in the following. SBAS corrections dΔtₛᵥ(t) to be added to Δtₛᵥ(t) are as follows:

dΔtₛᵥ(t)=da_{f0}+da_{f1}(t−t₀) (5)

i.e.

Δtsvc(t)=Δtₛᵥ(t)+dΔtₛᵥ(t) (6)

It can easily be verified that by modifying a_{f0},a_{f1},a_{f2} according to:

a_{f0c}=a_{f0}+da_{f0}+da_{f1}(t_{oc}−t₀) (7)

a_{f1c}=a_{f1}+da_{f1} (8)

a_{f2c}=a_{f2} (9)

and inserting (7)-(9) into (4), equation (4) becomes identical to (6). Finally, the resulting elements of a_{f0c} and a_{f1c} are mapped onto the nearest quantized values.

The step of modifying preferably comprises modifying of a value of at least one parameter of ephemeris equations of the assistance data of the assisted global positioning system. The following are selected equations of equations defining the SV coordinates (x,y,z) in Earth Centered Earth Fixed coordinate system as a function of time. Note that not all possible parameters are listed below for reducing the complexity of understanding.

Δt=t−tₒₑ

n=n₀+Δn

M=M₀+nΔt

M=E−e sin E

v=tan⁻¹{(1−e²) sin E/(cos E−e)}

E=cos−1{(e+cos n)/(1+e cos n)}

Φ=v+ω

du=cᵤₛ sin (2Φ)+c_{uc} cos (2Φ)

dr=cᵣₛ sin (2Φ)+c_{rc} cos (2Φ)

di=cᵢₛ sin (2Φ)+c_{ic} cos (2Φ)

u=F+du

r=A(1−e cos E)+dr

i=iO+di+(IDOT)t

x′=r cos u

y′=r sin u

Θ=Θ₀+(Θ′−Θₑ′)Δt+Θₑ′tₒₑ

x=x′ cos Θ−y′ cos i sin Θ

y=x′ sin Θ+y′ cos i cos Θ

z=y′ sin i (10)

The equations in (10) can be differentiated with respect to the time t, so that corresponding equations for the velocities are obtained. The SBAS long term corrections contain satellite position and velocity corrections. The general idea is to do a Taylor series expansion of the SV coordinates and velocity vector around a nominal parameter vector:

f(θ,t₀)=f(θ₀,t₀)+f(θ₀,t₀)(θ−θ₀) (11)

with

f(θ,t₀)=(x(θ,t₀)y(θ,t₀)z(θ,t₀)dx(θ,t₀)/dt dy(θ,t₀)/dt dz(θ,t₀)/dt)^{T} (12)

θ=(cᵤₛc_{uc}cᵣₛc_{rc}cᵢₛc_{ic}Θ′IDOT Δn)^{T} (13)

where the ith row of f is

f₁′(θ,t)=df₁/dθ^{T} (14)

Note that the parameter vector θ in the present embodiment does not include all ephemeris parameters transmitted by the SV. Also observe that the number of equations is smaller than the number of parameters. Therefore, the system of equations is solved for the minimum norm parameter vector θ using the SBAS corrections vector:

Δƒ=ƒ(θ,t₀)−ƒ(θ₀,t₀)=(dx dy dz dx dy dz)^{T} (15)

to obtain

Δθ=f(θ₀,t₀)^{T}(f(θ₀,t₀)f(θ₀,t₀)^{T})⁻¹Δf (16)

Finally, the resulting elements of θ=θ₀+Δθ are mapped onto the nearest quantized values.

The step of modifying preferably comprises modifying of a value of at least one standard parameter of an ionospheric model of the assistance data of the assisted global positioning system.

The ionospheric model comprises:

Tᵢ=F*[5.0*10⁻⁹+(AMP)(1−x²/2+x⁴/24)], |x|<1.57

Tᵢ=F*5.0*10⁻⁹, |x|>=1.57

AMP=α₀+α_{1φm}+α_{2φm}²+α_{3φm}³

If AMP<0AMP=0,

x=2π(t-50400)/PER

PER=β₀+β_{1φm}+β_{2φm}²+β_{3φm}³, PER>=72000

If PER<72000, PER=72000

F=1.0+16.0[0.53-E]³ (17)

The SBAS ionospheric correction can be computed quite exactly at the network node site. Similarly to the clock corrections and ephemeris, the results are matched so that a MS based AGS terminal arrives at the same ionospheric corrections as SBAS, but using the parameters α₀, . . . , α₃, β₀, . . . , β₃ instead. In this case there are 6 parameters but only one equation so the minimum norm solution will be taken. Generally:

Tᵢ(θ,t₀)=Tᵢ(θ₀,t₀)+Tᵢ′(θ₀,t₀)(θ−θ₀) (18)

The estimated modification to the original parameter vector is then

Δθ=Tᵢ′^{T}/(Tᵢ′^{T}Tᵢ′)ΔTᵢ (19)

where

Δθ=(θ−θ₀), ΔTᵢ=Tᵢ(θ,t₀) (20)

Finally, the resulting elements of θ=θ₀Δθ are mapped onto the nearest quantized values.

An appropriate selection of parameters can be made is somewhat different ways. Preferably, parameters representing somewhat different aspects are selected. Preferably, at least six parameters are used. At least one parameter has preferably a satellite position dependency, and at least one parameter has preferably a satellite velocity dependency.

The conversion can preferably also be based on SBAS corrections associated with more than one time instant. In such a way, the modified parameters are typically more reliable in time, and there are more equations to use for the matching. The data for different time instants, t0 and t₀+T, can be used for instance according to:

$$\{ \begin{matrix}Δ f ( θ , {t}_{0} ) \\ Δ f ( θ , {t}_{0} + T )\end{matrix} \} = \{ \begin{matrix}{f}^{′} ( {θ}_{0} , {t}_{0} ) \\ {f}^{′} ( {θ}_{0} , {t}_{0} + T )\end{matrix} \} ( θ - {θ}_{0} ) . \qquad ( 21 )$$

Here Δƒ(θ,t₀) is given by the SBAS corrections, while Δƒ(θ,t₀+T)=0. This is due to the fact that no SBAS corrections are known for the future and the original model is thereby the best available model. This prohibits the modified parameters to express a model that is good for the present time but leas to unreasonable values in a near future. The modifying of parameters of assistance data can thus be further based also on standard parameters of the assistance data intended for another time instant.

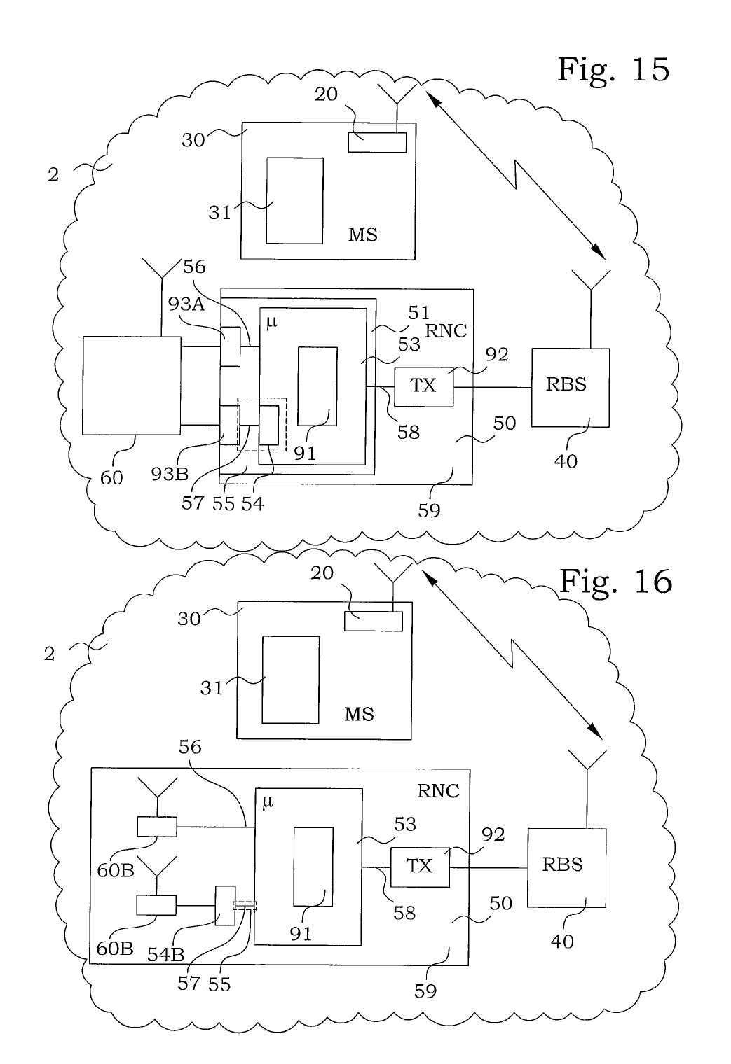

FIG. 15 illustrates an embodiment of a wireless communication system according to the present invention. A node 59 for use in a wireless communication system, in the present embodiment a RNC 50, comprises a satellite positioning interface 51, which is connected to a reference receiver 60, which in the present embodiment is capable of receiving and interpreting satellite signals both from the GPS system and from the SBAS satellites. The satellite positioning interface 51 comprises a processor 53. The processor 53 has an input 56 connected to a receiver 93A of SBAS correction data from the reference receiver 60. The processor 53 further comprises means 55 for obtaining AGPS assistance data, in the present embodiment consisting of an input 57, connected to a receiver 93B of GPS model data from the reference receiver 60, and an AGPS section 54. In the AGPS section, the information from the reference receiver 60 is processed into suitable AGPS assistance data for a MS 30 connected to the wireless communication system 2. The receivers 93A and 93B are merely logical units and may advantageously be implemented in a common means. The processor 53 has a modifying section 91 that is arranged for determining modified values of standard parameters of assistance data of the assisted global positioning system and/or correction data of differential global positioning system. The modified values of the standard parameters are achieved from the SBAS correction data and in further dependence on the AGPS assistance data according to the procedures described further above. The modified values of the standard parameters are provided through an output 58 connected to the processor 53, to a transmitter 92. The transmitter 92 is arranged for transmitting the modified values over the wireless communication system 2 to the MS 30.

In a system supporting standard AGPS, the modifying section 91 is arranged for modifying values of the standard parameters of the AGPS assistance data as obtained from the AGPS section 54 based on the SBAS correction data from the input 56 into the modified values that are provided to the transmitter 92.

If the wireless communication system 2 and the MS to which the modified AGPS assistance data is to be sent are supporting DGPS, the modifying section 91 may be arranged for calculation of a value of a parameter of range correction data of DGPS. The calculation is based on the SBAS correction data achieved via the input 56 and the AGPS assistance data as obtained from the AGPS section 54.

The actual way in which the original AGPS data and SBAS correction data are provided may differ between different embodiments. In FIG. 16, another embodiment of a wireless communication system 2 according to the present invention is illustrated. Here the node 59 includes also a first satellite signal receiver 60A, and a second satellite signal receiver 60B. The first satellite receiver 60A is arranged for receiving satellite signals from SBAS satellites. The first satellite receiver 60A is connected to the input 56 for being able to supply the requested SBAS correction data. The second satellite receiver 60B is arranged for receiving satellite signals from the GPS satellites and for extracting GPS model data therefrom. In the present embodiment, the second satellite receiver 60B is connected to an AGPS unit 54B, which has corresponding functions as the AGPS section 54 in FIG. 15. AGPS assistance data is therefore provided to the processor 53 directly over the input 57. In the present embodiment, the means 55 for obtaining AGPS assistance data thus comprises only the input 57.

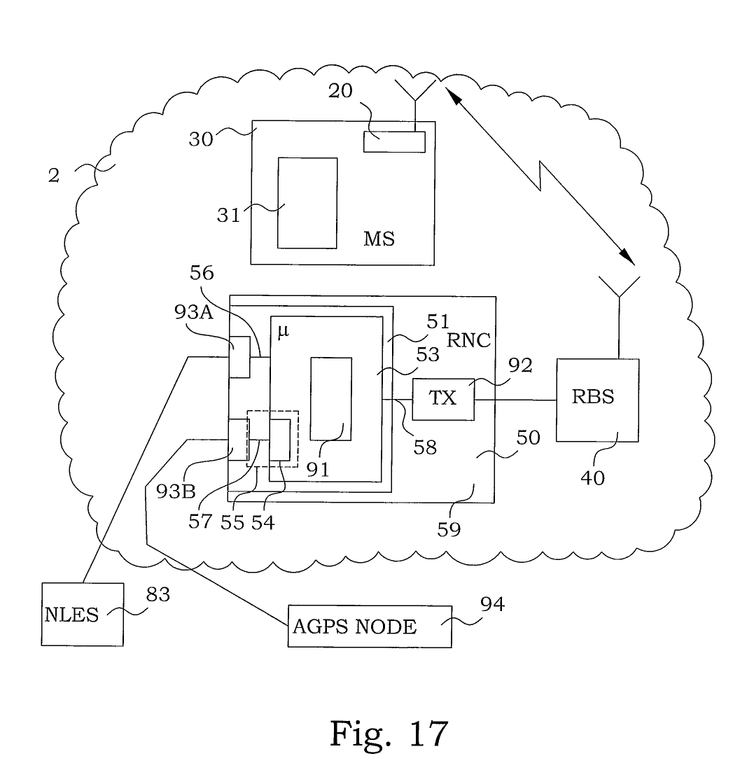

In FIG. 17, yet another embodiment of a wireless communication system 2 according to the present invention is illustrated. Here, the SBAS information and the GPS model data are collected from ground based sources instead. The node 59 comprises a first receiver 93A connected to a node of a SBAS network, e.g. a NLES node 83. The first receiver 93A is arranged for providing the processor 53 via the input 56 with SBAS correction data achieved from the NLES 83. The node 59 further comprising a second receiver 93B connected to the means 55 for obtaining AGPS assistance data. The second receiver 93B is further connected to a service node 94 for AGPS, which provides GPS data concerning the presently valid GPS models. Such a service node 94 may or may not be a part of the wireless communication system itself.

The node 59 for performing the conversion of the correction data can also be comprised in other parts of the communication system. It may e.g. be implemented in the base station controller, in any other core network node or as a completely separate network node. For instance, in a 3GPP system, a typical node in which the conversion capabilities may be implemented is in the SMLC (Serving Mobile Location Centre). Furthermore, in the examples above, a WCDMA system has been used as a model communication system. However, the present invention can be applied in any wireless communication system, and the node 59 performing the conversion of the correction data may be implemented together with different nodes of the different communication systems.

The embodiments described above are to be understood as a few illustrative examples of the present invention. It will be understood by those skilled in the art that various modifications, combinations and changes may be made to the embodiments without departing from the scope of the present invention. In particular, different part solutions in the different embodiments can be combined in other configurations, where technically possible. The scope of the present invention is, however, defined by the appended claims.

1. Method for providing a mobile station being connected to a wireless communication system with OPS assistance data, comprising the steps of:
obtaining correction data of a satellite based augmentation system in a node of said wireless communication system;
obtaining assistance data of an assisted global positioning system in said node of said wireless communication system;
determining modified values of standard parameters of assistance 10 data of said assisted global positioning system from said correction data of said satellite based augmentation system in dependence on said assistance data of said assisted global positioning system;
said standard parameters comprising at least one of:
a standard parameter of an ionospheric model;
a standard parameter of a clock correction; and
a standard parameter of ephemeris equations; and
transmitting said modified values of said standard parameters from said node to said mobile station.

2. Method according to claim 1, wherein said modifying comprises modifying of a value of at least one standard parameter of an ionospheric model of said assistance data of said assisted global positioning system.

3. Method according to claim 1, wherein said modifying comprises modifying of a value of at least one parameter of a clock correction of said assistance data of said assisted global positioning system.

4. Method according to claim 1, wherein said modifying comprises modifying of a value of at least one parameter of ephemeris equations of said assistance data of said assisted global positioning system.

5. Method according to claim 4, wherein said at least one parameter is at least six parameters.

6. Method according to claim 4, wherein said at least one parameter comprises parameters having a satellite position dependency.

7. Method according to claim 4, wherein said at least one parameter comprises parameters having a satellite velocity dependency.

8. Method according to claim 1, wherein said modifying comprises performing a Taylor expansion around a nominal parameter vector.

9. Method according to claim 1, wherein said modifying is further based on standard parameters of said assistance data intended for more than one time instant.

10. Method according to claim 1, wherein said step of obtaining correction data comprises receiving of said correction data of a satellite based augmentation system from at least one of a satellite based augmentation system node and a satellite based augmentation system satellite.

11. Node for use in a wireless communication system, comprising a processor;
an input connected to said processor, for correction data of a satellite based augmentation system;
said processor having means for obtaining assistance data of an assisted global positioning system;
said processor being arranged for determining modified values of standard parameters of assistance data of said assisted global positioning system from said correction data of said satellite based augmentation system in dependence on said assistance data of said assisted global positioning system;
said standard parameters comprising at least one of:
a standard parameter of an ionospheric model;
a standard parameter of a clock correction; and
a standard parameter of ephemeris equations; and output connected to said processor, for providing said modified values of said standard parameters.

12. Node according to claim 11, further comprising a first satellite receiver, connected to said input, for said correction data of said satellite based augmentation system.

13. Node according to claim 11 further comprising a receiver, connected to said input, and arranged for receiving said correction data of said satellite based augmentation system from a satellite based augmentation system node.

14. Node according to claim 11, further comprising a second satellite receiver connected to said means for obtaining said assistance data of said assisted global positioning system.

15. Node according to claim 11, further comprising a receiver connected to said means for obtaining said assistance data of said assisted global positioning system, and arranged for receiving said assistance data of said assisted global positioning system from an assisted global positioning system service node.

16. Node according to claim 11, further comprising a transmitter arranged for said modified values of said standard parameters over said wireless communication system.

17. Wireless communication system, comprising a node according to claim 11.
